(19) United States
(12) Patent Application Publication
(10) Pub. No.: US 2024/0167555 A1
(43) Pub. Date: May 23, 2024

(54) GEAR

(71) Applicant: Miba Sinter Austria GmbH, Laakirchen (AT)

(72) Inventor: Horst ROESSLER, Krenglbach (AT)

(73) Assignee: Miba Sinter Austria GmbH, Laakirchen (AT)

(21) Appl. No.: 18/517,254

(22) Filed: Nov. 22, 2023

(30) Foreign Application Priority Data
Nov. 23, 2022 (AT) A50885/2022

(51) Int. Cl. F16H 55/06; B21D 53/28; B22F 3/16; B22F 5/08; F16H 55/17

(52) U.S. Cl. CPC F16H 55/06; B21D 53/28; B22F 3/162; B22F 5/08; F16H 55/17; B22F 2998/10; F16H 2055/065

(57) ABSTRACT

A gear from a sintering powder has a first track and a second track, wherein the first track is a first cylindrical gear toothing with first teeth and with a first diameter and the second track is a second cylindrical gear toothing with second teeth and with a second, in comparison to the first diameter of the first track larger, diameter, and wherein depressions are configured on the first teeth of the first track in a transition region adjoining the second track.

### CROSS REFERENCE TO RELATED APPLICATIONS

Applicant claims priority under 35 U.S.C. § 119 of Austrian Application No. A50885/2022 filed Nov. 23, 2022, the disclosure of which is incorporated by reference.

### BACKGROUND OF THE INVENTION

### 1. Field of the Invention

The invention relates to a gear from a sintering powder with a first track and a second track, wherein the first track is a first toothing with first teeth and with a first diameter and the second track is a second toothing with second teeth and with a second, in comparison to the first diameter of the first track larger, diameter.

The invention further relates to a method for powder-metallurgically producing a gear from a sintering powder with a first track and a second track, wherein a first toothing with first teeth and with a first diameter is produced as the first track, and a second toothing with second teeth and with a second, in comparison to the first diameter of the first track larger, diameter is produced as the second track, comprising the steps: pressing the sintering powder to a green compact; sintering the green compact to the sintered gear, rolling at least the track with the first diameter.

The invention further relates to a tool for rolling a gear with a first track and a second track, wherein the first track is a first toothing with first teeth and with a first diameter, and the second track is a second toothing with second teeth and with a second, in comparison to the first diameter of the first track larger, diameter, wherein the tool comprises a tool body, which has a first section and a second section.

### 2. Description of the Related Art

In electric vehicles and hybrid applications, so-called E-axles are used in the drive unit. In the prior art, the term “E-axle” refers to solutions for the electric drive of battery-powered electric vehicles and hybrid applications. The electric motor used, which converts electrical energy into mechanical energy, transfers the torque onto a gearbox. The gearbox translates the rotational speed of the electric motor to the level required at the drive shaft and simultaneously amplifies the motor torque. E-axles are often equipped with single-stage or two-stage cylindrical gears or planetary gears. This enables axially parallel or coaxial architectures to be implemented.

In planetary gearboxes, stepped planetary gears (double planetary gears) having different gear diameters are used to realize the translation. The toothings of the double planetary gears mesh on the one hand with the sun gear and on the other hand with the internal gear. The toothings, in particular the angular positions in helical toothings, must be manufactured with high precision as assembly of the planetary gearbox will otherwise not, or not easily, be possible.

For NVH reasons (noise, vibration, harshness), the toothings of components of a planetary gearbox, in particular of the double planetary gears, are hard and fine processed, following a heat treatment, to equalize the warpages. Due to the geometric conditions (interfering contour), the small toothing of a double planetary gear is processed by tooth honing, as a rule. It is state of the art to turn a plunge cut in the transition region from the small toothing to the web of the large toothing in order to create a clearance for the hone processing. It is known that the service lives of honing rings drop significantly and/or honing ring fractures (i.e. tool fractures) occur if the small toothing immediately adjoins the first toothing. In powder-metallurgical solutions of double planetary gears, the small toothing runs directly up to the web of the large toothing for reasons of pressing practice. However, also known is a powder-metallurgical solution, in which the two tracks of the double planetary gear are spaced apart.

Such a double planetary gear, a method and a tool for its production are known, for example, from AT 521 836 A2. In accordance with this document, a green compact is produced from a sintering powder with a first track and a second track, wherein the first track has a first helical toothing and the second track has a second helical toothing. The sintering powder is filled into a mold cavity of a die and is subsequently pressed to a green compact with an upper stamp and a lower stamp. The sintering powder, after having been filled into the die, is partially moved into the upper stamp and the upper stamp is used as a further die for the formation of the first track. A web is formed between the two tracks using the upper stamp and the lower stamp. The gear produced from this green compact is formed as one piece. After the web is removed, a ring groove is configured between the two tracks.

### SUMMARY OF THE INVENTION

The object underlying the present invention is to improve the production of a single-piece double gear and/or make available a corresponding gear.

The object of the invention is achieved with the gear mentioned in the beginning, in which depressions are configured on the teeth of the first track in a transition region adjoining the second track.

The object of the invention is further achieved with the method mentioned in the beginning, according to which depressions are created by the rolling operation on the teeth of the first track in a transition region adjoining the second track.

In addition, the object of the invention is achieved with the tool mentioned in the beginning, in which the first section and the second section for rolling the first track are provided and the second section has a larger diameter than the first section.

Here, it is of advantage that the roll processing of the gear simultaneously also creates a clearance, with which the hone processing of the smaller toothing of the gear can be improved. In particular, the honing can be carried out in a more tool-protecting manner. The roll processing in accordance with the invention, therefore, allows to save an additional process step, which is carried out in the prior art for forming the ring groove, thereby improving the productivity of the method. Here, in particular the porosity of sintered components is of advantage, as the pores in the component enable its compaction, thereby supporting the formation of the depressions.

In accordance with one embodiment variant of the invention, it can be provided that the depressions are configured and/or formed at a distance to the second track which is selected from a range of 0.1 mm to 6 mm. This small spacing of the depressions enables the rolling tool to be arranged spaced apart from the second track, thereby facilitating the roll processing. To that end, the tool can comprise multiple sub-sections in the second section, wherein one sub-section has the larger diameter in comparison to the first section and wherein another sub-section is arranged between this sub-section with the larger diameter and a front face of the tool body.

According to another embodiment variant of the invention, it can be provided that the depressions are configured and/or formed only in the tooth flanks and optionally the tooth tips, thereby also facilitating the roll processing.

Yet, alternatively and according to one embodiment variant of the invention, it can also be provided that the depressions in the teeth of the first track are configured and/or formed immediately abutting on one another, so that they form an uninterrupted recess in circumferential direction along the entire first toothing. On the one hand, this enables hone processing to be carried out in two directions of rotation if required, on the other hand, it enables the first toothing in the transition region between the two tracks to have a higher root strength of the teeth, thereby improving the service life of the gear during bending stress of the first track.

To reduce tolerances, it can be provided according to other embodiment variants of the invention that the depressions have, or are produced with, a depth between 0.02 mm and 1 mm and/or that the depressions have, or are produced with, a width between 0.5 mm and 5 mm in an axial direction of the gear.

Preferably, the tool in accordance with one embodiment variant of the invention is configured such that the first section is arranged immediately adjoining the second section, so that the roll processing can be carried out with a purely rotational movement, without axial feed.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a multi-track gear in an oblique view;

FIG. 2 shows an E-axle;

FIG. 3 shows a section from an embodiment variant of a gear;

FIG. 4 shows a tool for producing the gear according to FIG. 1; and

FIG. 5 shows a section from the tool according to FIG. 4.

### DETAILED DESCRIPTION OF PREFERRED EMBODIMENTS

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, these specifications of location are to be analogously transferred to the new position.

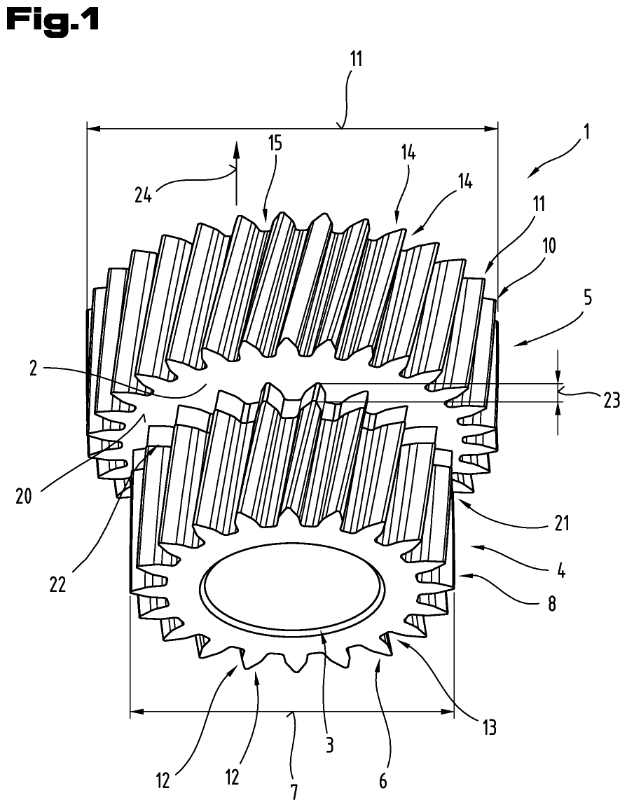

FIG. 1 shows a gear 1. The gear 1 has a gear body 2. In the gear body 2, a recess 3, which extends in axial direction, in particular through the gear 1, is formed to accommodate a shaft or axle that is not represented. On its radial exterior surface, the gear body 2 further has a first track with a first cylindrical gear toothing 4 in the form of helical toothing and a second track with a second cylindrical gear toothing 5 in the form of helical toothing. Yet, at least one of the cylindrical gear toothings can also be configured differently, for example as spur toothing. Further, the two helical toothings can be inclined in the same direction (as show in FIG. 1) or in opposite directions.

The first track has first teeth 6 and a first diameter 7. The first diameter 7 is measured between first tooth tips 8 of the first teeth 6.

The second track has second teeth 9 and a second diameter 10. The second diameter 10 is measured between second tooth tips 11 of the second teeth 9.

The first teeth 6 have first tooth flanks 12, which extend from the first tooth tips 8 up to first tooth roots 13.

The second teeth 9 have second tooth flanks 14, which extend from the second tooth tips 11 up to second tooth roots 15.

The terms “tooth tip,” “tooth flank” and “tooth root” are used in accordance with the technical usage for gears.

As can been seen from FIG. 1, the first diameter 7 of the first track is smaller than the second diameter 10 of the second track.

The gear 1 is preferably intended for a multi-stage, for example two-stage, planetary gear with double-row planets. Yet, the gear 1 can also be utilized in other applications.

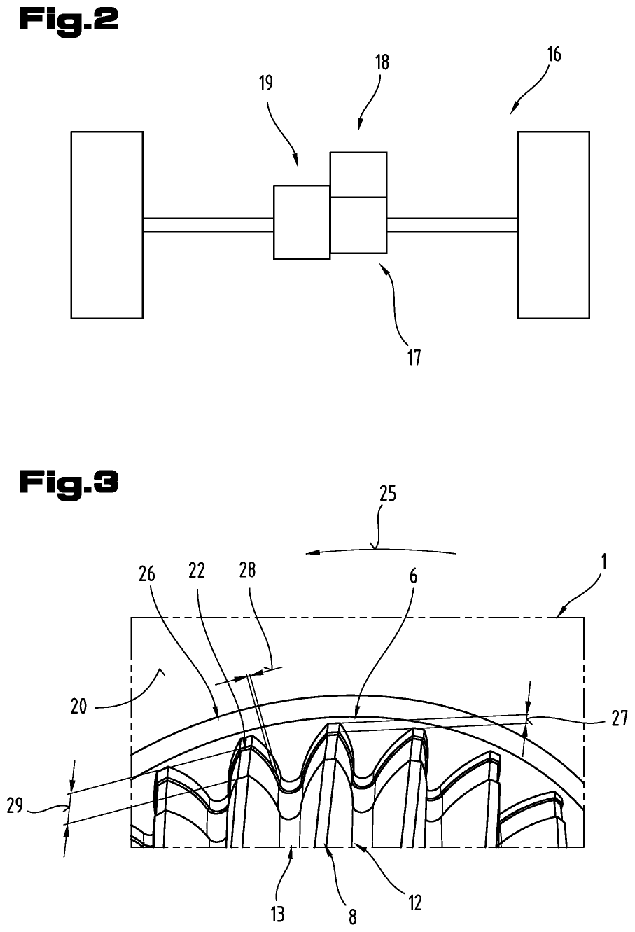

In particular, the gear 1 is intended for an E-axle 16 of an electric vehicle, which is represented in a simplified manner and by way of example in FIG. 2. Besides an electric motor 17 and the power electronics 18, the E-axle 16 also comprises a planetary gearbox 19 with the gear 1 as the planetary gear. As is generally known, a planetary gearbox 19, besides the at least one planetary gear, also comprises a central sun gear and an internal gear surrounding all gears, wherein the internal gear is in operative connection with the sun gear via the at least one planetary gear.

The gear 1 is produced powder-metallurgically from a, in particular metal, sintering powder. The sintering powder can, for example, be a steel powder, wherein other (pre-alloyed) powders can be used as well. Further, the powder can have the usual additives, such as, for example, lubricants, etc. In a first step, this (optionally pre-mixed) sintering powder is pressed to a so-called green compact. The pressing of the powder to the green compact can be done, for example, with a powder press known from the prior art.

The green compact is sintered to produce the sintered gear 1. The sintering of the green compact can be done in a single or multi-stage operation in accordance with the prior art. In this respect, reference is made to the relevant prior art. The temperatures during sintering can amount to between 750° C. and 1350° C., for example. The green compact 16 can be kept at this temperature for between 10 minutes and 65 minutes.

Before the sintering, the green compact can optionally be processed mechanically, for example machined. Further, the sintered gear 1 is reworked mechanically in order to reduce the tolerances at least of the first cylindrical gear toothing 4, optionally also of the second cylindrical gear toothing 5. The reworking is done in particular by honing. A honing ring can be used for honing.

Alternatively or additionally to the honing, the reworking can optionally also be carried out by grinding, etc. Besides the machine reworking, the first, and optionally also the second, cylindrical gear toothing 4, 5 are rolled. The rolling can, in principle, be carried out on the green compact. Yet, preferably, the rolling is (additionally) done on the sintered gear 1 in order to achieve a re-compaction at least of the peripheries of the toothing(s).

Further, the sintered gear 1 can be hardened at least in the region of the first and/or second cylindrical gear toothing.

As these method steps are generally known, reference is made to the relevant prior art for more detail.

As can be seen from FIG. 1, the first track immediately adjoins an axial front face 20 of the second track, which means that no ring groove is configured between the first and the second track, such as this is known from the prior art, such as, for example, from the abovementioned AT 521 836 A2. In other words, the first track is connected to the second track (formed on the second track) over the entire tooth depth. To improve the hone processing and/or generally the machine processing of the first track, i.e. the first teeth 6, it is provided that depressions 22 are configured on the teeth 6 of the first track in a transition region 21 adjoining the second track.

The transition region 21 can have a width 23 in an axial direction 24 which is selected from a range of 0.05 mm to 8 mm, in particular 0.05 mm to 5 mm and/or to 4 mm. The width 23 is measured in the axial direction 24 starting at the front face 20.

The depressions 22 may be configured on only one of the two tooth flanks 12 or preferably on two tooth flanks 12 of the first teeth 6 of the first cylindrical gear toothing 4 and optionally also in the first tooth tips 8 of the first cylindrical gear toothing 4, such as this is represented in FIG. 1. Yet, according to one embodiment variant of the gear 1, a detail of which is represented in FIG. 3, it can also be provided that the depressions 22 extend into the first tooth roots 13 and that the depressions 22 in the first teeth 6 of the first track care configured immediately abutting on one another, so that they form an uninterrupted recess (a continuous groove) in circumferential direction along the entire first cylindrical gear toothing 4.

It can also be seen from FIG. 3 that a hub 26 is arranged on the axial front face 20 of the second track, which hub 26 is immediately adjoined by the first cylindrical gear toothing 4 and protrudes beyond the first teeth 6 of the first cylindrical gear toothing 4 in radial direction.

The depressions 22 can be configured in the first teeth 6, immediately adjoining the second track, such as this is represented in FIG. 1. However, according to another embodiment variant of the gear 1, it can also be provided that the depressions 22 are configured as starting at a distance 27 to the second track, such as this is represented in FIG. 3. The distance 27 can be selected from a range of 0.1 mm to 6 mm.

According to embodiment variants of the gear 1, the depressions 22 can have a depth 28 between 0.02 mm and 1 mm, in particular between 0.05 mm and 0.5 mm, and/or a width 29 in the axial direction 24 (see FIG. 1) of the gear 1, between 0.5 mm and 5 mm.

The depressions 22 can be configured with a consistent depth 28 or with a depth 28 that varies in circumferential direction. Also the width 29 of the depressions 22 can be configured consistent or varying.

The depressions 22 can have a quadrangular, for example rectangular or trapezoid, cross section (viewed in the direction perpendicular to the axial direction 24), wherein, in case of a trapezoid cross section, the width 29 of the depressions 22 decreases in the direction towards the bottom of the depressions 22. Also other cross-sectional shapes of the depressions 22 are possible.

In an embodiment variant of the depressions 22 with a width 29 that decreases in the direction towards their bottom in the axial direction 24, the side walls of the depressions 22 can include an angle with the bottom of the depressions 22 selected from a range of 95° to 120°. This enables the hone processing to be improved due to improved positionability of the honing ring.

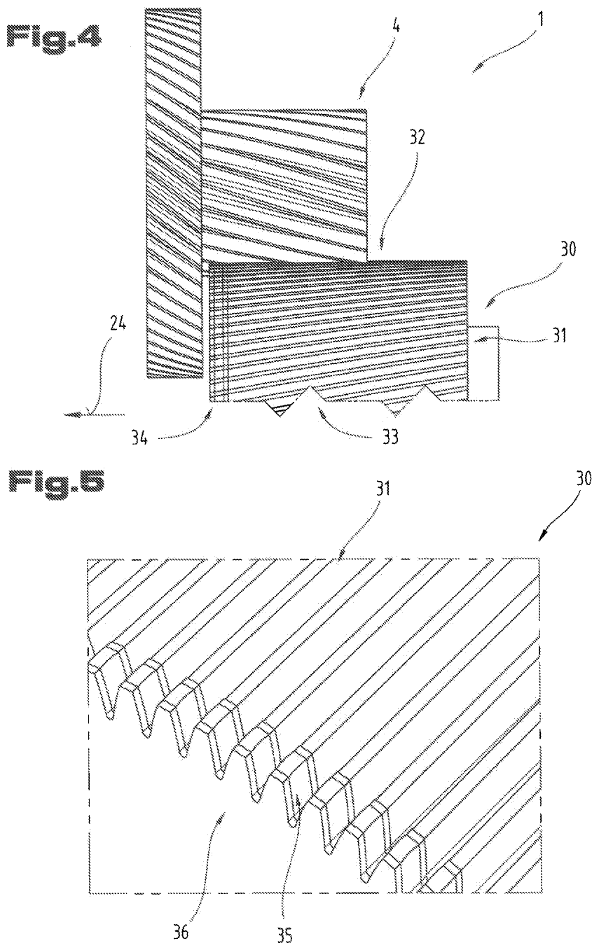

In the preferred embodiment of the invention, the depressions 22 are produced while rolling the first cylindrical gear toothing 4. In this context, FIGS. 4 and 5 show an embodiment variant of a tool 30 (rolling tool). FIG. 4 shows the tool 30 resting against the first cylindrical gear toothing 4 of the gear 1 in a working position, and FIG. 5 shows a detail of same.

The tool 30 has a tool body 31, on which a cylindrical gear toothing 32 is arranged and/or configured. The cylindrical gear toothing 32 has a correspondingly high precision. Therefore, it may be referred to as molded toothing. Preferably, the cylindrical gear toothing 32, in the axial direction 22, has at least a width which corresponds to at least the width of the first cylindrical gear toothing 4 of the first track of the gear 1, so that it is not necessary to adjust the tool 30 during rolling of the first cylindrical gear toothing 4. Yet, the cylindrical gear toothing 32 of the tool 30, in the axial direction 24, can also have a smaller width than the first cylindrical gear toothing 4.

For the desired roll forming processes to take place on the cylindrical gear toothing 4 of the gear 1, corresponding rolling forces must act between the cylindrical gear toothing 32 of the tool 30 and the first cylindrical gear toothing 4. These can be caused by applying force to the tool 30 in an at least approximately radial direction. This can be done by pushing the tool 30 in the radial direction with a corresponding force. This force applied in radial direction causes the rolling forces acting between the gear 1 and tool 30, which can mount to extremely high values, depending on the ratio of sizes, in particular on the ratio of diameters of the toothings meshing with one another during rolling.

The roll processing can also be performed simultaneously on multiple tools 30 (of the same kind).

For roll processing, the gear 1 or the tool 30 or both can be set in rotational motion with a rotary drive. Preferably, however, only the tool 30 is driven.

The tool body 31 has a first section 33 with a first section of the cylindrical gear toothing 31 and a second section 34 with a second section of the cylindrical gear toothing 31. Here, the cylindrical gear toothing 31 can be formed as one piece, i.e. the two sections 33, 34 can be formed as one piece with each other. Yet, it can also be provided that the second section 34 is formed by a separate form rolling wheel, which is connected, in a form-fitting and/or friction-fitting manner, to the form rolling wheel that forms the first section 33.

The first section 33 and the second section 34 are provided for rolling the first cylindrical gear toothing 4 of the first track. Yet, the second section 34, i.e. its cylindrical gear toothing, has a larger diameter, at least in one sub-region, than the first section 33, so that this sub-region forms the depressions 22 in the first cylindrical gear toothing 4 of the first track of the gear 1. This sub-region of the second section 34 may extend along its entire width in the axial direction 24, or only part of this width, such as this is represented in FIG. 5 by means of the elevations 35. Essentially, the form of the elevations 35 and their position on the second section 34 of the tool 30 is determined by the desired form and placement of the depressions 22 of the first cylindrical gear toothing 4 of the gear 1.

Due to the elevations 35, the second section 34 has multiple (at least two) sub-sections, wherein one sub-section has the larger diameter in comparison to the first section 33 and wherein another sub-section is arranged between this sub-section with the larger diameter and a front face 36 of the tool body 32. In the embodiment variant of the tool 30 according to FIG. 5, the second section 34 has three sub-sections, wherein only the center sub-section is configured with the larger diameter, i.e. with the elevations 35.

Preferably, the second section 34 of the tool 30 is arranged immediately adjoining the first section 33.

According to another embodiment variant, it is also possible for the tip diameter of the tool section of the tool 30 that abuts on the first track to be smaller than that of the main tool section for compacting the cylindrical gear toothing 4. In this case, no depressions 22 are generated on the root diameter of the gear 1. The depressions 22 are therefore formed only on the tooth flanks 12.

The exemplary embodiments show and describe possible embodiment variants, wherein also combinations of the individual embodiment variants with one another are possible.

Finally, as a matter of form, it should be noted that for ease of understanding of the structure of the gear 1 and/or of the tool 30, these are not necessarily depicted to scale.

Although only a few embodiments of the present invention have been shown and described, it is to be understood that many changes and modifications may be made thereunto without departing from the spirit and scope of the invention.

### LIST OF REFERENCE NUMBERS

1 gear
2 gear body
3 recess
4 cylindrical gear toothing
5 cylindrical gear toothing
6 tooth
7 diameter
8 tooth tip
9 tooth
10 diameter
11 tooth tip
12 tooth flank
13 tooth root
14 tooth flank
15 tooth root
16 E-axle
17 electric motor
18 power electronics
19 planetary gear
20 front face
21 transition region
22 depression
23 width
24 axial direction
25 circumferential direction
26 hub
27 distance
28 depth
29 width
30 tool
31 cylindrical gear toothing
32 tool body
33 section
34 section
35 elevation
36 front face

What is claimed is:

1. A gear (1) from a sintering powder with a first track and a second track, wherein the first track is a first cylindrical gear toothing (4) with first teeth (6) and with a first diameter (7) and the second track is a second cylindrical gear toothing (5) with second teeth (9) and with a second, in comparison to the first diameter (7) of the first track larger, diameter (10), wherein depressions (22) are configured on the first teeth (6) of the first track in a transition region (21) adjoining the second track.

2. The gear (1) according to claim 1, wherein the depressions (22) are configured at a distance (27) to the second track selected from a range of 0.1 mm to 6 mm.

3. The gear (1) according to claim 1, wherein the depressions (22) are configured only in the tooth flanks (12) and optionally the tooth tips (8).

4. The gear (1) according to claim 1, wherein the depressions (22) in the first teeth (6) of the first track are configured immediately abutting on one another, so that they form an uninterrupted recess in circumferential direction (25) along the entire first cylindrical gear toothing (4).

5. The gear (1) according to claim 1, wherein the depressions (22) have a depth (28) between 0.02 mm and 1 mm.

6. The gear (1) according to claim 1, wherein the depressions (22) have a width (29) between 0.5 mm and 5 mm in an axial direction (24) of the gear (1).

7. A method for powder-metallurgically producing a gear (1) from a sintering powder with a first track and a second track, wherein a first cylindrical gear toothing (4) with first teeth (6) and with a first diameter (7) is produced as the first track and a second cylindrical gear toothing (5) with second teeth (9) and with a second, in comparison to the first diameter (7) of the first track larger, diameter (10) is produced as the second track, comprising the steps: pressing the sintering powder to a green compact; sintering the green compact to the sintered gear (1), rolling at least the track with the first diameter (7), wherein the rolling generates depressions (22) on the first teeth (6) of the first track in a transition region (21) adjoining the second track.

8. The method according to claim 7, wherein the depressions (22) are generated at a distance (27) to the second track selected from a range of 0.1 mm to 6 mm.

9. The method according to claim 7, wherein the depressions (22) are produced only in the tooth flanks (12) and optionally the tooth tips (8).

10. The method according to claim 7, wherein the depressions (22) in the teeth (6) of the first track are configured immediately abutting on one another, so that they form an uninterrupted recess in circumferential direction (25) along the entire first cylindrical gear toothing (4).

11. The method according to claim 7, wherein the depressions (22) are produced with a depth (28) between 0.02 mm and 1 mm.

12. The method according to claim 7, wherein the depressions (22) are produced with a width (29) between 0.5 mm and 5 mm in an axial direction (24) of the gear (1).

13. A tool (30) for rolling a gear (1) with a first track and a second track, wherein the first track is a first cylindrical gear toothing (4) with first teeth (6) and with a first diameter (7) and the second track is a second cylindrical gear toothing (5) with second teeth (9) and with a second, in comparison to the first diameter (7) of the first track larger, diameter (10), wherein the tool (30) has a tool body (32) having a first section (33) and a second section (34) that adjoins the first section (33) in an axial direction (24), wherein the first section (33) and the second section (34) are provided for rolling the first track and the second section (34) has, at least partially, a larger diameter than the first section (33).

14. The tool (30) according to claim 13, wherein the second section (34) has multiple sub-sections, wherein one sub-section has the in comparison to the first section (33) larger diameter and wherein another sub-section is arranged between this sub-section with the larger diameter and a front face (36) of the tool body (32).

15. The tool (30) according to claim 13, wherein the first section (33) is arranged immediately adjoining the second section (34).
